(19) United States
(12) Patent Application Publication
(10) Pub. No.: US 2019/0130328 A1
(43) Pub. Date: May 2, 2019

(54) METHODS AND SYSTEMS FOR SIMULATING AND OPTIMIZING A WORK ENVIRONMENT USING AN AGENT BASED MODEL FOR SCHEDULING AND STAFFING OF RESOURCES

(71) Applicant: CONDUENT BUSINESS SERVICES, LLC, Dallas, TX (US)

(72) Inventors: Shivani SHUKLA, San Francisco, CA (US); Gregory KOTT, Fairport, NY (US)

(73) Assignee: CONDUENT BUSINESS SERVICES, LLC, Dallas, TX (US)

(21) Appl. No.: 15/796,299

(22) Filed: Oct. 27, 2017

(51) Int. Cl. G06Q 10/06

(52) U.S. Cl. CPC G06Q 10/06311; G06Q 10/06398; G06Q 10/06312

(57) ABSTRACT

A method for simulating and optimizing performance of work in a distributed work environment includes determining operational parameters for one or more locations, and optimizing a staffing function using the operational parameters to produce a staffing schedule. The method includes determining one or more batches to be processed by the regular operators and ad-hoc operators of the one or more locations, and optimizing a task function using the staffing schedule and specifications of the different tasks to produce an assignment of the one or more batches to each of the regular operators and the ad-hoc operators at the one or more locations. The method includes optimizing a routing function using the assignment of the one or more batches to the operators at the one or more locations to produce a sequenced schedule of performance for the one or more batches.

### TECHNICAL BACKGROUND

One of the distinguishing challenges in transaction processing remains staffing, shift scheduling, job allocation, and job scheduling in the presence of variable and uncertain workloads and work rates. While these have been dealt with individually, no solution currently exists that unites these challenges into an end-to-end agent-based simulation that encompasses optimization, thereby, removing the need for heuristics and adopting a hybrid approach. A non-heuristics based method can be adopted for a wider realm of business and technical issues.

For example, an entity may utilize a large workforce that manually performs tasks required to meet customers Service Level Agreements (SLAs). The workforce may be spread across different locations around the world, operating in different time zones, shift schedules, and pay rates. In this scenario, large volumes of tasks fluctuate on a yearly, monthly, and daily basis. Currently, the staffing of the locations, scheduling of workers, and assignment of tasks to workers is done on an ad-hoc basis. This can result in overstaffing, mismatched skill to job assignments, missed SLAs and lost opportunities for cost and time savings.

Moreover, distributed work environments rely on the use of computer networks, such as the Internet. Often, the tasks performed by the workforce include processing electronic files that must be distributed to the different locations over the networks. As such, it is important that the electronic files are correctly distributed to the different locations. For example, if the work is incorrectly distributed, the work may need to be retransmitted to different locations, which can consume needed network resources and add potential delay to the completion of the tasks.

### Overview

Exemplary embodiments described herein include systems, methods, and processing nodes for simulating and optimizing performance of work in a distributed work environment. An exemplary method for simulating and optimizing performance of work in a distributed work environment includes determining operational parameters for one or more locations. The one or more locations include regular operators and ad-hoc operators. The method further includes optimizing a staffing function using the operational parameters to produce a staffing schedule. The staffing function defines a cost for work performed by the regular operators and the ad-hoc operators subject to service level agreement constraints. Also, the method includes determining one or more batches to be processed by the regular operators and ad-hoc operators of the one or more locations. The one or more batches includes different tasks to be performed. Additionally, the method includes optimizing a task function using the staffing schedule and specifications of the different tasks to produce an assignment of the one or more batches to each of the regular operators and the ad-hoc operators at the one or more locations. The task function defines availability of the regular operators and the ad-hoc operators based on the staffing schedule and the specifications of the different tasks of the different tasks in the one or more batches. The method also includes optimizing a routing function using the assignment of the one or more batches to each of the regular operators and the ad-hoc operators at the one or more locations to produce a sequenced schedule of performance for the one or more batches assigned to each of the regular operators and ad-hoc operators. The routing function defines an order of performance of the one or more batches based on the assignment of batches. Further, the method includes transmitting the batches, the staffing schedule, the assignment, and the sequenced schedule to the one or more locations.

An exemplary system for simulating and optimizing performance of work in a distributed work environment includes a processing node and a processor coupled to the processing node. The processor configures the processing node to perform operations including determining operational parameters for one or more locations. The one or more locations include regular operators and ad-hoc operators. The operations further include optimizing a staffing function using the operational parameters to produce a staffing schedule. The staffing function defines a cost for work performed by the regular operators and the ad-hoc operators subject to service level agreement constraints. Also, the operations include determining one or more batches to be processed by the regular operators and ad-hoc operators of the one or more locations. The one or more batches includes different tasks to be performed. Additionally, the operations include optimizing a task function using the staffing schedule and specifications of the different tasks to produce an assignment of the one or more batches to each of the regular operators and the ad-hoc operators at the one or more locations. The task function defines availability of the regular operators and the ad-hoc operators based on the staffing schedule and the specifications of the different tasks of the different tasks in the one or more batches. The operations also include optimizing a routing function using the assignment of the one or more batches to each of the regular operators and the ad-hoc operators at the one or more locations to produce a sequenced schedule of performance for the one or more batches assigned to each of the regular operators and ad-hoc operators. The routing function defines an order of performance of the one or more batches based on the assignment of batches. Further, the operations include transmitting the batches, the staffing schedule, the assignment, and the sequenced schedule to the one or more locations.

A non-transitory computer readable medium stores instructions for causing one or more processors to perform a method for simulating and optimizing performance of work in a distributed work environment. The method includes determining operational parameters for one or more locations. The one or more locations include regular operators and ad-hoc operators. The method further includes optimizing a staffing function using the operational parameters to produce a staffing schedule. The staffing function defines a cost for work performed by the regular operators and the ad-hoc operators subject to service level agreement constraints. Also, the method includes determining one or more batches to be processed by the regular operators and ad-hoc operators of the one or more locations. The one or more batches includes different tasks to be performed. Additionally, the method includes optimizing a task function using the staffing schedule and specifications of the different tasks to produce an assignment of the one or more batches to each of the regular operators and the ad-hoc operators at the one or more locations. The task function defines availability of the regular operators and the ad-hoc operators based on the staffing schedule and the specifications of the different tasks of the different tasks in the one or more batches. The method also includes optimizing a routing function using the assignment of the one or more batches to each of the regular operators and the ad-hoc operators at the one or more locations to produce a sequenced schedule of performance for the one or more batches assigned to each of the regular operators and ad-hoc operators. The routing function defines an order of performance of the one or more batches based on the assignment of batches. Further, the method includes transmitting the batches, the staffing schedule, the assignment, and the sequenced schedule to the one or more locations..

### BRIEF DESCRIPTION OF THE DRAWINGS

FIG. 1 depicts an example of a distributed work environment, according to various embodiments of the present disclosure.

FIG. 2 depicts an exemplary method for simulating and optimizing a work environment, according to various embodiments of the present disclosure.

FIGS. 3A-3C depicts example results from a simulation and optimization of a work environment, according to various embodiments of the present disclosure.

FIG. 4 depicts an exemplary processing node for performing simulation of a work environment, according to various embodiments of the present disclosure.

### DETAILED DESCRIPTION

According to embodiment of the present disclosure, a work simulator can utilize an Agent Based Model (ABM) simulation and optimization formulations to provide near-optimal solutions to staffing, scheduling, and routing of jobs. In embodiments, batches of different tasks can be collected and distributed to different geographically dispersed locations for processing by operators. For example, electronic documents can be moved from onshore to offshore for manual operations and processing by operators.

In embodiments, the work simulator determines a staffing schedule for the locations using hybrid approach including agent based simulation and mixed-integer optimization. For example, the work simulator can determine specific details of which operator works on which days of the week (the schedule is weekly) for how many hours, on which tasks, at which location, by considering the off days, work rates, maximum number of shifts they can work on. Once the staffing schedule is determined, the work simulator utilizes a virtual queue that is built up before the batches are assigned to one of the locations and its operators. In embodiments, the work simulator can determine the schedules of each operator for a stipulated period of time for each location, which leads to total number of operators required at every given day.

In embodiments, the work simulator also determines an assignment of batches (also referred to as jobs or tasks), to operators at each location. Once the batches are assigned, the work simulator determines which batches get assigned to which operator depending on their work rates and availability and a sequence in which batches will be processed and completed by each operator so that the Service Level Agreements are met. In the ABM model utilized by the work simulator, the agent populations can be defined: (i) Operators at each location, and (ii) Task types, which are autonomous. Attributes of operators can be defined in terms of their work rates and shift/workday preferences of the respective locations. Certain tasks types can require more time than others due to their complexity, which form the attributes of these agents.

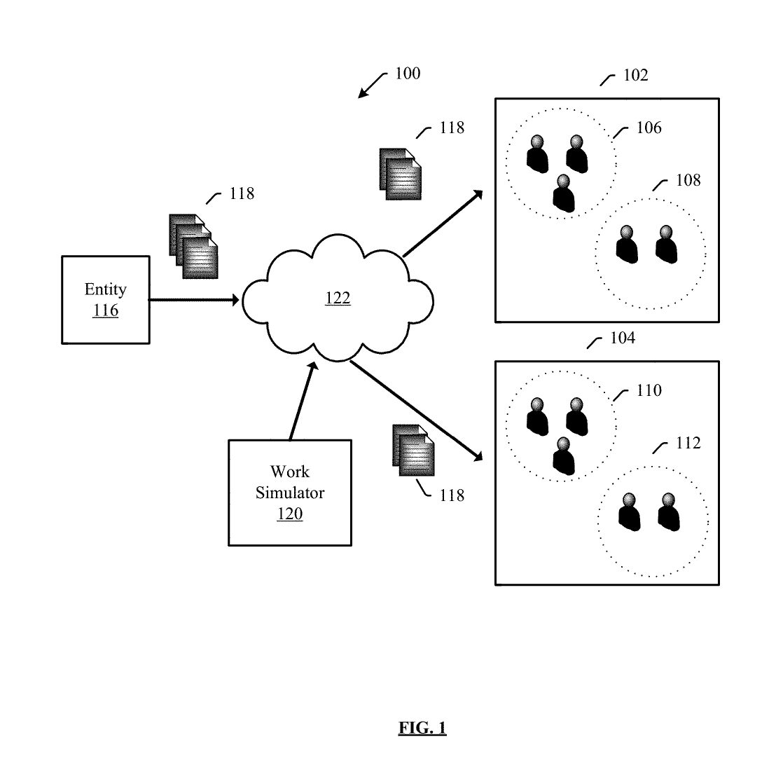

In embodiments, in the ABM model, the operators also act as resource pools and can shrink or expand in population dynamically, making the model different from other discrete event simulation models. In the ABM model, the agents interact with each other in the sense that which operators get picked and which jobs go first/last gets decided. The agents interact with the environment in the sense that they learn on their job with time and get better in terms of work rates. This localized decision-making results in a behavior toward a self-organizing system. These and additional operations are further described with respect to the embodiments depicted in FIGS. 1-4 below.

FIG. 1 illustrates an example of a distributed work environment 100, according to embodiments of the present disclosure. While the distributed work environment 100 illustrates various components, one skilled in the art will realize that additional components can be added and existing components can be removed.

As illustrated in FIG. 1, the distributed work environment 100 includes several distributed work locations 102 and 104 (hereinafter “locations”). The locations 102 and 104 can be geographically separated, for example, located in different regions, countries, etc. The location 102 can include a number of regular operators 106 and a number of ad-hoc operators 108. Likewise, the location 104 can include a number of regular operators 110 and a number of ad-hoc operators 112. The regular operators 106, 110 can be the regular workers or employees of the location 102, 104. The ad-hoc operators 108, 112 can be temporary or on-demand employees of the location 102, 104.

In embodiments, an entity 116 may desire to utilize the locations 102 and 104 to perform batches (jobs or tasks) related to objects 118. For example, the objects 118 can be one or more documents that require manual processing, for example, data entry, data validation, data review, etc. In one example, the object 118 can include medical forms that require manual data entry, data review, etc. As such, the entity 116 may desire to utilize the regular operators 106, 110 and the ad-hoc operators 108, 112 to perform the batches (tasks or jobs).

In embodiments, to allocate the objection 118 to the locations 102, 104, the distributed work environment 100 includes a work simulator 120. The work simulator 120 can be configured to schedule the regular operators 106, 110 and the ad-hoc operators 108, 112 at the locations 102 and 104. The work simulator 120 can be configured to distribute the objects, e.g. documents, and assign the batches (jobs or tasks) to the regular operators 106, 110 and the ad-hoc operators 108, 112.

In embodiments, the work simulator 120 can be implemented on one or more processing nodes. For example, the work simulator 120 can be implemented as an application program that is executed on the one or more processing nodes. The processing nodes can be any type of computer systems that are capable of performing the processes and methods described herein and communicating with the entity 116, the location 102, and the location 104 via one or more networks 122. In embodiments, the one or more networks 122 can include more public and/or private networks, whether wired or wireless.

For example, the processing nodes can include one or more server computers, one or more desktop computers, one or more laptop computer, one or more tablet computers, one or more mobile devices, and the like. In any example, the processing node can include hardware resources (processors, memory, storage, etc.) and software resources (operating systems, application programs, etc.) to perform the process and methods described herein. As illustrated, the work simulator 120 can be implemented in one or more processing nodes that are separate from the entity 116, the location 102, and the location 104. Likewise, the work simulator 120 can be implemented at one or more processing nodes that are located at the entity 116, the location 102, the location 104, or combinations thereof.

While FIG. 1 illustrates two locations, one skilled in the art, using the disclosures provided herein, will appreciate that the work simulator 120 can simulate scheduling for any number of location and operators at the locations.

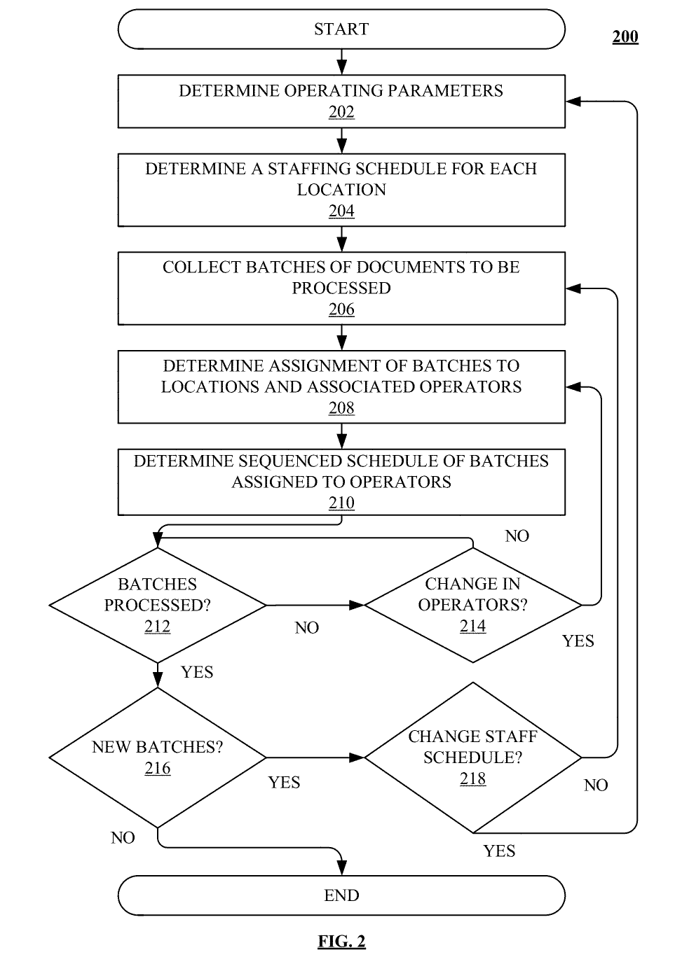

FIG. 2 depicts an exemplary method for 200 for simulating and optimizing the schedule and work assign in one or more locations. Although FIG. 2 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

After the process begins, in 202, the operating parameters are determined for one or more locations. The operating parameters can include information that describes the operators available at the locations (e.g., number, type (regular or ad-hoc), identification, etc.), and describes the historic scheduling and performance of the operators (e.g., previous schedule of the operators, work history of the operators, performance data of the operators, etc.).

In some embodiments, the work simulator 120 can monitor and collect the operating parameters from the locations, for example, the entity 116, location 102, location 104, and combination thereof. In some embodiments, the work simulator 120 can receive the operating parameters from the location 102, the location 104, the entity 116, and combination thereof.

In 204, a staffing schedule is determined for each location. The work simulator 120 can determine a schedule for each location that includes the staffing of operators at each location for each day and each shift.

The model for staffing schedule, used by the work simulator 120, can be defined as follows.

Sets

[symbol] :={1, . . . , L}: Set of locations. For example, locations can be one for more locations such as the location 102 and the location 104. For instance, a location can be an offshore location where the data entry process takes place. In the model, let i denote each location.

S:={1, . . . , S}: Set of shifts. A shift can be a defined time period for a set of operators to work at a location such as the location 102 and the location 104. For example, each location can define up to three shifts at each location. In this example, described below, the location 102 and the location 104 can have two shifts per location. For varied number of locations per location, the set Sᵢ, ∀i=1, . . . L. In the model, each shift is denoted by j.

[symbol] :={1, . . . , K}: Set of document types. Each document to be processed can have an associated type based on different characteristics that influence the work rates. For example, for various kinds of medical claim forms processed for manual data entry, each claim form has different characteristics that influence the work rates. In the model, each document type is denoted by k.

[symbol] :={1, . . . , Eᵢ}: Set of regular operators at each location. In the model, let e denote each operator.

[symbol] :={1, . . . , D}: Set of ad-hoc operators. The ad-hoc operators can be temporary or on-demand operators. For example, the ad-hoc operators can be operators that are pulled from other departments to handle high volume days and maintain SLAs. In the model, each ad-hoc operator is denoted by d.

{ [symbol] T₁, T₂, . . . Tₜ_{₁}}a subset of T: Sets of weeks. In the model, it can be assumed that data for a complete week is fed to the model, in other words,

$$\frac{T}{7}$$

is a whole number. Each day is denoted by t ∈ T; t=1, . . . , T, and each week is given by

$${t}_{1} ; {t}_{1} = 1 , … , \frac{T}{7} .$$

For generality (without the assumption), each week is given by

$${t}_{1} ; {t}_{1} = 1 , … , ⌊ \frac{T}{7} ⌋ . ,$$

thereby, disregarding certain days that do not form a complete week.

Parameters

n̅ᵢ is the maximum number of work days at location i, where n̅ᵢ≥nᵢ.

nᵢ is the minimum number of work days for operators at location i, where nᵢ≥0.

MAX is the number of maximum operators for the project at all locations, and adMAX is the number of maximum ad-hoc operators at all locations, where MAX≥0.

costᵢⱼₜ is the cost of a regular operator at location i, for shift j, and on day t, where costᵢⱼₜ>0. The model can incorporate a variation in costs at different locations (an operator in India might be paid more than an operator in Philippines), shift (a night shift might entail a higher cost than a day shift), and day (operators might charge higher during weekends) dimensions.

adhoccostᵢⱼₜ is the cost of an ad-hoc operator at location i, for shift j, and on day t, adhoccostᵢⱼₜ>0.

smaxᵢ is the maximum number of shifts an operator can work at each location i, where smaxᵢ>0.

rateₑₖ is the rate (tasks per unit time) at which a regular operator e works on document type k, where rateₑₖ≥0.

adhocratee_{dk} is the rate (task per unit time) at which an ad-hoc operator d works on document type k, adhocratee_{dk}≥0.

claimrateᵢₖₜ is the rate (task per unit time) at which task arrive at location i consisting of document type k on day t, claimrateᵢₖₜ≥0.

Decision Variables

xᵢⱼₖₜ:=the number of regular operators working shift j ∈ S on location i ∈ [symbol] , document type k ∈ [symbol] , and day t ∈

[symbol]

vᵢⱼₖₜ:=the number of ad-hoc operators working shift j ∈ S on location i ∈ [symbol] , document type k ∈ [symbol] and day t ∈

[symbol]

yₑⱼₖₜ:=an assignment variable that takes on value 1 if operator e; e=1, . . . , Eᵢ, is selected for working shift j ∈ S, on document type k ∈ [symbol] , day t ∈ [symbol] , and 0 otherwise.

z_{idjkt}:=an assignment variable that takes on value 1 if ad-hoc operator d working shift j ∈ S on location i ∈ [symbol] , document type k ∈ [symbol] , and day t ∈ [symbol] , and 0 otherwise.

Problem Formulation

Minimize Z=Σᵢ₌₁^{L}Σⱼ₌₁^{S}^{ᵢ}Σₖ₌₁^{K}Σₜ₌₁^{T}[costᵢⱼₜxᵢⱼₖₜ+adhoccoustᵢⱼₜvᵢⱼₖₜ] (1)

Subject to Constraints:

Σₖ₌₁^{K}yₑⱼₖₜ≤1, e=1, . . . , Eᵢ, i=1, . . . , L, j=1, . . . , Sᵢ, t=1, . . . , T (2)

nᵢ≤Σₖ₌₁^{k}Σⱼ₌₁^{S}^{ᵢ} [symbol] yₑⱼₖₜ≤nᵢ, e=1, . . . , Eᵢ, i=1, . . . , L (3)

Σⱼ₌₁^{S}^{ᵢ}Σₖ₌₁^{k}yₑⱼₖₜ≤smaxᵢ, i=1, . . . , L, e=1, . . . , Eᵢ, t=1, . . . T (4)

Σₑ₌₁^{E}^{ᵢ}yₑⱼₖₜ=xᵢⱼₖₜ, i=1, . . . , L, j=1, . . . , Sᵢ, K=1, . . . , K, t=1, . . . T (5)

Σ_{d=1}^{D}z_{ifjkt}=vᵢⱼₖₜ, i=1, . . . , L, j=1, . . . , Sᵢ, K=1, . . . , K, t=1, . . . T (6)

vᵢⱼₖₜ≤xᵢⱼₖₜ, i=1, . . . , L, j=1, . . . , Sᵢ, K=1, . . . , K, t=1, . . . T (7)

Σᵢ₌₁^{L}Σⱼ₌₁^{S}^{ᵢ}Σₖ₌₁^{K}xᵢⱼₖₜ≤MAX, t=1, . . . T (8)

Σᵢ₌₁^{L}Σⱼ₌₁^{S}^{ᵢ}Σₖ₌₁^{K}vᵢⱼₖₜ≤adMAX, t=1, . . . T (9)

Σₜ₌ₜ^{t+q}Σⱼ₌₁^{S}^{ᵢ}[Σₑ₌₁^{E}^{ᵢ} rateₑₖyₑⱼₖₜ+Σ_{d=1}^{D} adhocrate_{dk}z_{idjkt}]≥Σₜ₌ₜ^{t+q} claimrateᵢₖₜ, i=1, . . . , L, k=1, . . . , K (10)

$$\frac{1}{T} {\sum }_{t = 1}^{T} {\sum }_{j = 1}^{{S}_{i}} [ {\sum }_{e = 1}^{{E}_{i}} {rate}_{ek} {y}_{ejkt} + {\sum }_{d = 1}^{D} {adhocrate}_{dk} {Z}_{idjkt} ] \geq {\sum }_{{t = 1}_{l < T}}^{l} {claimrate}_{ikt} , i = 1 , … , L , k = 1 , … , K \qquad ( 11 )$$

xᵢⱼₖₜvᵢⱼₖₜ≥0; yₑⱼₖₜz_{idjkt} is binary, ∀e, d, i, j, k, t (12)

In the model, the objective function is to minimize staffing costs for regular operators and ad-hoc operators. Because the goal is to manage incoming volumes of tasks with regular operators, during application, the adhoccostᵢⱼₜ coefficients are much higher than costᵢⱼₜ. The first set of constraints (1) manage the assignment of operators without duplications. Constraints (3) impose upper and lower limits on the number of work days a regular operator will have to work on location i. Constraints (4) ensures that any operator at any location on any day does not work for more than a prescribed number of shifts. The formulation above also creates cells in the sense that a particular operator works on a particular document type per the particular operator's schedule and work rates, so as to balance the particular operator's constitution for each document type. That is, the model will not assign all the operators with high work rates onto the most demanding task, but creates a judicious balance. In some embodiments, the constraint that a certain operator can only work on a certain document type can be relaxed with simple mathematical modification.

Constraints (5) and (6) connect the total number of regular/ad-hoc operators with the assignment variables. Because the latter are binary, Xᵢⱼₖₜ and Vᵢⱼₖₜ are not integers. Constraints (7) ensures that on any given day and shift, on any given location, and for any given document type, the ad-hoc operators are less than the regular operators. Constraints (8) and (9) provide upper bounds on the variables.

Constraints (10) and (11) cater to the service level agreement (SLA) requirements. For example, the constraints (10) and (11) show that a given claim would not stay in process for more than q amount of days and average time taken to process claims would not exceed a certain day limit, 1. In one example, q=5, l≈1.

In embodiment, the model described above is solved using the operational parameters applied to a technique of optimization plus ABM. Various combination of the operational parameters can be tried to optimize the problem formulation. The work simulator can be designed in terms of ABM. For example, the problem formation can be solved with the optimization formulations through a Branch and Cut algorithm implemented on a solver that can be included in the work simulator 120, for example, commercially available solver produced by Gurobi™. For example, the solver can utilize an algorithm that performs the following steps: 1. Solve relaxation of the integer linear problem solver, for example, Simplex; 2. Proceed with the fractional solution; 3. Add an inequality that violates the current fractional solution but satisfies all integer points (global or local (current subtree) cuts); 4. Implement Branch and Bound; 5. Repeat, if necessary.

In embodiments, to implement the ABM, the work simulator can be designed using simulator tool, such as a commercially available tool Anylogic™. The Branch and Cut algorithm for our formulations can be coded, for example, using Java, and included in simulator tool for optimization.

In 206, batches of documents to be processed are collected. In embodiments, the work simulator 120 can maintain a virtual queue of batches. As the batches arrived, the work simulator 120 can add the batches to the virtual queue. Once the virtual queue has reached a predetermined level, the work simulator 120 can assigned the batches to the location and operators as discussed below.

In some embodiments, other processing may be performed on the batches of documents prior to assignment to the locations. For example, the physical documents can be scanned and converted to electronic documents. Likewise, data can be extracted from the documents to aid in the assignment, for example, to identify the type of document.

In 208, the assignment of batches to locations and associated operators is determined. In embodiments, the work simulator 120 implements an Agent Based Model (ABM) for simulation that focuses on the use of agents for the generation of model behavior in a system evaluation.

In embodiments, the work simulator implements a formulation that can be adapted from the classic Bin packing problems and job shop scheduling problems. In the formulation, the Integer Programming formulation allocates jobs to available operators. Because the regular and ad-hoc operators were already selected, as discussed above, e′; e′=1, . . . , Eᵢ′; denotes every regular operator in the selected subset of operators at location i. Similarly, d′; d′=1, . . . , D′ denotes every ad-hoc operator in the selected subset for all location. In some embodiments, it is possible that there are no ad-hoc operators selected in which case corresponding variables in the following formulations will be zero. The model for assigning the batches, used by the work simulator 120, can be defined as follows.

Parameters

batchsizeₘₖ: Number of jobs in a batch with id m; m=1, . . . , Mⱼₜ for task type k, where batchsizeₘₖ≥0. Note that each batch has a unique id and can have any task type, but not multiple task types per batch.

a_{me′k}¹: Because batches were assigned to operators, this parameter denotes the size of the batch in terms of time taken to process the batch, where

$${a}_{{me}^{′}}^{1} = {{batchsize}_{mk} ( \frac{seconds}{claim} )}_{{e}^{′} k} {a}_{{me}^{′} k}^{1} \geq 0.$$

a_{md′k}²: Similar to the above, this represents the time taken to process a job m of task type k by operator d′, where a_{md′k}²≥0.

V_{e′jt}¹: Time available to each operator e′ in location i during shift j and day t, in other words, operator handling capacity. Note that this time available is monitored to record remaining time in the shift, where V_{e′}=total time in the shift—current time and V_{e′jt}¹≥0.

V_{d′jt}²: Time available to each operator d′ during shift j and day t, where v₂ⱼₜ¹≥0.

Results of y_{e′jkt} and z_{id′jkt} from 203, described above, are employed as parameters here.

Decision Variables

g_{me′}¹: 1 if job m is assigned to operator e′ during shift j and day t; 0 otherwise.

g_{mid′}²: 1 if job m is assigned to operator d′ at location i during shift j and day t; 0 otherwise.

Problem Formulation

Minimize Bⱼₜ=Σᵢ₌₁^{L}Σ_{e′=1}^{E′}^{ᵢ}Σₘ₌₁^{M}^{ⱼₜ}g_{me′}¹+Σᵢ₌₁^{L}Σ_{d′=1}^{D′}Σₘ₌₁^{M}^{ⱼₜ}g_{mid′}² (13)

Subject to the following constraints;

Σₘ₌₁^{M}Σₖ₌₁^{K}a_{me′k}¹g_{me′}¹≤Σₖ₌₁^{K}V_{e′jt}¹y_{e′jkt}∀e′, i, j, t (14)

Σₘ₌₁^{M}Σₖ₌₁^{K}a_{md′k}²g_{mid′}²≤Σₖ₌₁^{K}V_{d′jt}²z_{id′jkt}∀e′, i, j, t (15)

Σᵢ₌₁^{L}Σ_{e′=1}^{E′}^{ᵢ}g_{me′}¹+Σᵢ₌₁^{L}Σ_{d′=1}^{D′}g_{mid′}²=1, ∀m, j, t (16)

g_{me′}¹, g_{mid′}²is binary (17)

In the model, the objective function is to optimize the utilization of selected operators in every shift and on every day. Set of constraints (14) and (15) show that time taken to finish jobs to be allocated to a regular or ad-hoc operator will be less than that operator's temporal handling capacity. Constraints (16) make sure that a certain job (batch) is allocated only once to a certain location and either a regular or an ad-hoc operator, thereby, eliminating duplication. This formulation provides the model with an allocation paradigm, basically answering which operator will work on which job in which location.

In embodiment, the model described above is solved using the operational parameters applied to a technique of optimization plus ABM. Various combination of the operational parameters can be tried to optimize the problem formulation. The work simulator can be designed in term of ABM. For example, the problem formation can be solved the optimization formulations through a Branch and Cut algorithm implemented on a solver that can be included in the work simulator 120, for example, commercially available solver produced by Gurobiυ. For example, the solver can utilize an algorithm that performs the following steps: 1. Solve relaxation of the integer linear problem solver, for example, Simplex; 2. Proceed with the fractional solution; 3. Add an inequality that violates the current fractional solution but satisfies all integer points (global or local (current subtree) cuts); 4. Implement Branch and Bound; 5. Repeat, if necessary.

In embodiments, to implement the ABM, the work simulator can be designed using simulator tool, such as a commercially available tool Anylogic™. The Branch and Cut algorithm for our formulations can be coded, for example, using Java, and included in simulator tool for optimization.

In 210, the sequenced schedule of batches assigned to operators is determined. In embodiments, the work simulator 120 implements an Agent Based Model (ABM) for simulation that focuses on the use of agents for the generation of model behavior in a system evaluation.

In embodiments, the work simulator utilizes a Mixed Integer Linear Programming formulation for scheduling jobs for every operator at every location during each shift every day. This formulation is associated with the one above (208).

The model for assigning the batches, used by the work simulator 120, can be defined as follows.

Parameters

α_{e′jt}¹α_{id′jt}²: Weights assigned to tardiness of jobs handled by regular and ad-hoc operators respectively in the objective function, where α_{e′jt}¹, α_{id′jt}²≥0.

β_{e′jt}¹, β_{id′jt}²: Weights assigned to earliest start time of jobs handled by [0097] regular and ad-hoc operators respectively in the objective function, where β_{e′jt}¹, β_{id′jt}² could be positive or negative depending on the objective.

α_{me′}¹: Processing time of job m performed by operator e′, where α_{me′}¹≥0.

α_{md′}²: Processing time of job m performed by operator d′, where α_{md′}²≥0.

[symbol] : A very large value.

d̅ₘ: Due time of job m, where d̅ₘ>0.

r̅ₘ: Release time of job m, where r̅ₘ>0.

Results g_{me′}¹ and g_{mid′}², from 208, described above, are employed as parameters here.

Decision Variables

Tdₘ¹: Tardiness of job m for regular operators.

Tdₘ²: Tardiness of job m for ad-hoc operators.

r_{me′}¹: Earliest start time of job m for operator e′.

r_{mid′}²: Earliest start time of job m for operator d′.

z_{mm′e′}¹: 1 if job m precedes m′; 1, . . . Mⱼₜ for operator e′; 0 otherwise.

z_{m′me′}¹: 1 if job m′precedes m for operator e′; 0 otherwise.

z_{mm′id′}²: 1 if job m precedes m′; 1, . . . Mⱼₜ for operator d′; 0 otherwise.

z_{m′mid′}²: 1 if job m′ precedes m for operator d′; 0 otherwise.

Problem Formulation

$$Minimize {JSS}_{{ie}^{′} {d}^{′} jt} = {\sum }_{m = 1}^{{M}_{jt}} [ {α}_{{e}^{′} jt}^{1} {Td}_{m}^{1} + {α}_{{id}^{′} jt}^{2} {Td}_{m}^{2} ] + {\sum }_{m = 1}^{{M}_{jt}} [ {β}_{{e}^{′} jt}^{1} {r}_{{me}^{′}}^{1} + {β}_{{id}^{′} jt}^{2} {r}_{{md}^{′}}^{2} ] \qquad ( 18 )$$

z_{mm′e′}¹+z_{m′me′}¹≤g_{me′}¹, ∀m, m′, m≠m′, e′, i, j, t (19)

z_{mm′e′}¹+z_{m′me′}¹+1≥g_{me′}¹+g_{m′e′}¹, ∀m, m′, m≠m′, e′, i, j, t (20)

r_{me′}¹+a_{me′}¹− [symbol] (1−z_{mm′e′}¹)≤r_{m′e′}¹, ∀m, m′, m≠m′, e′, i, j, t (21)

r_{m′e′}¹+a_{m′e′}¹− [symbol] (1−z_{m′me′}¹)≤r_{me′}¹, ∀m , m′m≠m′, e′, i, j, t (22)

r_{me′}¹≥r̅ₘ, ∀m, e′, i, j, t (23)

Tdₘ¹=max{r_{me′}¹+a_{me′}¹, −d̅ₘ, 0} (24)

Alternatively,

Tdₘ¹≥0 ∀m, j, t; Tdₘ¹≥r_{me′}¹+a_{me′}¹−d̅ₘ, ∀m, d′, i, j, t (25)

z_{mm′id′}²+z_{m′mid′}²≤g_{mid′}², ∀m, m′, m≠m′, d′, i, j, t (26)

z_{mm′id′}²+z_{m′mid′}²+1≥g_{mid′}²+g_{m′id′}², ∀m, m′, m≠m′, d′, i, j, t (27)

r_{mid′}²+a_{md′}²− [symbol] (1−z_{mm′id′}^{d})≤r_{m′id′}², ∀m, m′, m≠m′, d′, i, j, t (28)

r_{m′id′}²+a_{m′d′}²− [symbol] (1−z_{m′mid′}²)≤r_{mid}², ∀m, m′, m≠m′, d′, i, j, t (29)

r_{mid′}²≥r̅ₘ, ∀m, d′, i, j, t (30)

Tdₘ²≥0∀m, j, t; Tdₘ²≥r_{mid′}²+a_{md′}²−d̅ₘ, d′, i, j, t (31)

r_{me′}¹≥0, ∀m, e′, i, j, t; r_{mid′}²≥0, ∀m, d′, i, j, t; z_{mm′e′}¹, z_{m′me′}¹, z_{mm′id′}², z_{m′mid′}² (32)

In the model, in the work simulator 120, the objective function minimizes the tardiness and the earliest start times of all jobs for each regular and ad-hoc operator. The α¹, α² and β¹, β² factors ascertain the weights assigned to each of these objectives. Usual queuing heuristics are first-in-first-out, shortest processing time, earliest due date, and so on. The model above, however, helps achieve the goal of least tardiness and quick start of the job while considering the processing times, an optimization model that balances various objectives regulated by parameters α¹, α² and β¹, β². Note that the values of these parameters can be different for every location, every operator, during any shift on any day. Constraints (19)-(24) are for the regular operators, while (26)-(31) are for ad-hoc operators. If m and m′ are to be performed on by the same operator, constraints (19) and (26) make sure that either m is worked on or m′. Constraints (20) and (27) ensure that at least one of the z¹ or z² variables take on value 1. Switching constraints (21), (22), and (28),(29) ensure the sequence of jobs m and m′ for each operator. Due to (19)-(20) and (26)-(27), (22) and (29) can be redundant. Constraints (23) and (30) ensure that start time of a job is always greater than the time at which the job is released to be worked on. Equations (24) and (31) define the tardiness.

In embodiment, the model described above is solved using the operational parameters applied to a technique of optimization plus ABM. Various combination of the operational parameters can be tried to optimize the problem formulation. The work simulator can be designed in term of ABM. For example, the problem formation can be solved the optimization formulations through a Branch and Cut algorithm implemented on a solver that can be included in the work simulator 120, for example, commercially available solver produced by Gurobi™. For example, the solver can utilize an algorithm that performs the following steps: 1. Solve relaxation of the integer linear problem solver, for example, Simplex; 2. Proceed with the fractional solution; 3. Add an inequality that violates the current fractional solution but satisfies all integer points (global or local (current subtree) cuts); 4. Implement Branch and Bound; 5. Repeat, if necessary.

In embodiments, to implement the ABM, the work simulator can be designed using simulator tool, such as a commercially available tool Anylogic™. The Branch and Cut algorithm for our formulations can be coded, for example, using Java, and included in simulator tool for optimization.

Once the batches are assigned and the sequenced schedule is determined, the batches of documents can be forwarded to the locations for processing by the operators. In embodiments, the progress of the processing of the batches can be monitored by the work simulator 120. In 212, it can be determined whether the batches have been processed at the location. For example, the work simulator 120 can monitor the progress of the locations on processing the batches.

If the batches have not been processed, in 214, it can be determined whether the location have a change in operators. For example, one or more of the locations may have a change in operators (e.g., out due to sickness or leave, addition of regular operators, firing of regular operators, etc.) In some embodiments, the work simulator 120 can monitor the status of the operators at the locations. If there is a change in operators, the process can return to 208, and the batches can be reassigned and a new sequenced schedule of bathes can be determined. For example, if the work simulator determines a change in the operators, the work simulator 120 can perform 208 and 210 to determine if work should be reassigned or rescheduled based on the change in operators. If there is no change in operators, the work simulator 120 can continue to monitor to progress in processing the batches (212).

If the batches have been processed, in 216, it can be determined whether there are new batches to be processed. For example, as current batches are processed, the work simulator 120 can collect new batches to be processed and place the new batches in the virtual queue. If the new batches reach the predetermined threshold, the work simulator can determine an assignment of the new batches and the sequenced schedule of the new batches. In some embodiments, the scheduling of the new batches can be performed after the current batches are processed. In some embodiments, the scheduling of the new batches can be performed while the current batches are being processed.

If new batches are available, in 218, it can be determined whether the staff schedule is changed. For example, the work simulator 120 can determine whether the staff schedule should be changed. The determination to change the staff schedule can be based on the amount of time since the last determination of staff schedule, a change in the staff at the locations, the addition or removal of a location, and the like. If the staff schedule is to be changed, the method 200 can return to 202. For example, the work simulator 120 can determine new operating parameters and repeat the process of determining the staff schedule, assigning the new batches to operators, and determining the sequenced schedule of batches. In some embodiments, the new operating parameters can include information about new operators, information about new locations, performance data collected from the current batches being processed, and the like.

If it is determined not to change the staff schedule is in 218, the method 200 can return to 208, and the new batches can be assigned and a sequenced schedule of bathes can be determined for the new batches. If no new batches are to be processed, the method 200 can end.

While the above method 200 is described in term of processing documents, one skilled in the art will realize the method can be applied to virtually any situation that requires staffing, scheduling, and/or allocation.

The work simulator 120, utilizing the method 200 described above, provides an improvement over existing work simulators. One of the distinguishing challenges in transaction processing remains shift scheduling, job allocation, and job scheduling in the presence of variable workloads and work rates. While these conventionally have been dealt with individually, the work simulator 120, utilizing the method 200 described above, unites them into an end-to-end simulation. The work simulator 120, utilizing the method 200 described above, provides a hybrid approach of including schedule, staff, and resource allocation optimization formulations into a simulation for better near-optimal solutions as opposed to approximations derived from a simulation-only approach.

In embodiments, the work simulator 120, utilizing the method 200 described above, provides further improvements by learning from historical data to identify optimal staffing, scheduling, and allocation related savings when looked at in a unified manner (one affecting the other). For a given workload, location, schedule, pay and skill combination, the work simulator 120, utilizing the method 200 described above, helps identify the most efficient subset of operators to complete the workload and satisfy the SLAs. The work simulator 120, utilizing the method 200 described above, provides improvements by Accommodating days-off, schedule preferences, volume changes, and so on to arrive at practical and better sub-optimal instead of total approximations. The work simulator 120, utilizing the method 200 described above: Individualized schedules for each operator on a periodic basis; schedule and allocation regime for incoming work that includes specific objectives and is not limited to commonly used one-size-fits-all techniques.

Further, agent based models were traditionally built on heuristics such that approximate solutions were obtained. The work simulator 120, utilizing the method 200 described above, provides improvements by optimizing models for the following decisions into our ABM and builds a hybrid model to simulate and optimize: (i) Integrated staffing and scheduling of operators, (ii) Allocation of jobs to operators, and (iii) Sequencing/scheduling jobs within the operators' realm of work (allocated jobs). The work simulator 120, utilizing the method 200 described above, provides exact solutions obtained through the optimization formulations that when included into the ABM lead to an overall better sub-optimal solution for the simulation. The work simulator 120, utilizing the method 200 described above, eliminates dependence on classic queuing policies can be eliminated. The work simulator 120, utilizing the method 200 described above, is multi-objective to weigh each of the policy goals for personalized treatment. The work simulator 120, utilizing the method 200 described above, provides: (i) Allocation/Routing of jobs during every shift and every time period to operators selected as per the results from (Assignment of operators of a location to a shift and a task type during a particular time period; Staff requirements during any given time period), and (ii) Sequencing/scheduling of jobs within the allocated jobs for each operator, on every location, during each shift every time period.

The work simulator 120, utilizing the method 200 described above, also improves the execution of the models on a computer system. By optimizing and integrating the models, the work simulator 120, utilizing the method 200 described above, can operate on a computer system more efficiently that reduces the resources required to perform the staffing and scheduling simulations.

Moreover, the work simulator 120 improves the use and allocation of network resources. By utilizing the method 200, the work simulator 120 identifies optimal distributions of tasks performed by the workforce, for example, processing electronic files. As such, it enhances the efficiency of network usage and prevents the consummation of network resources by avoiding the need to redistribute the tasks due to incorrect staffing.

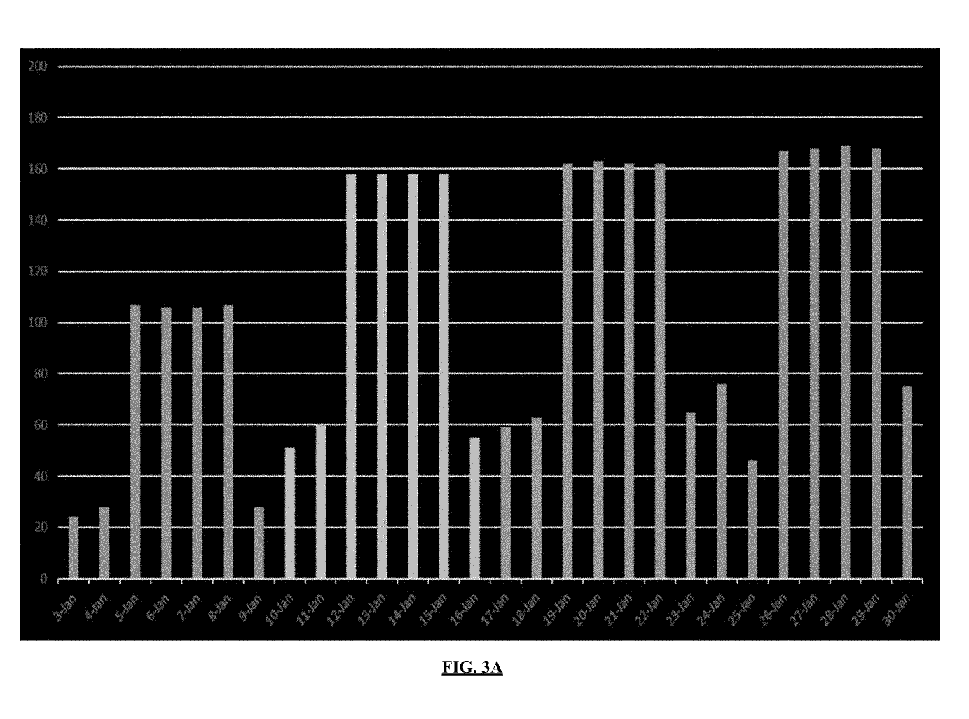

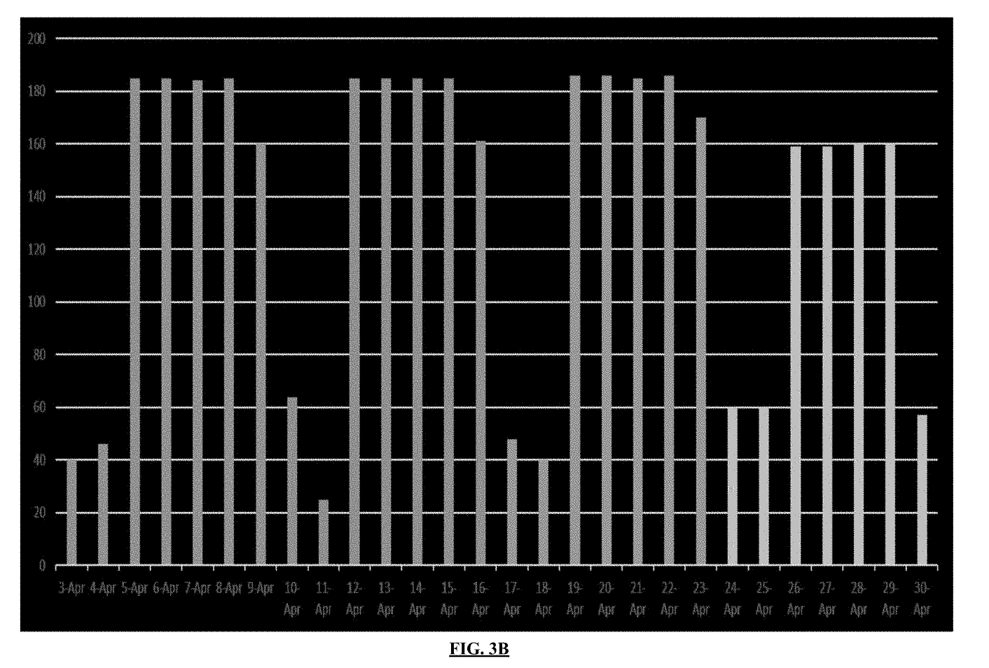

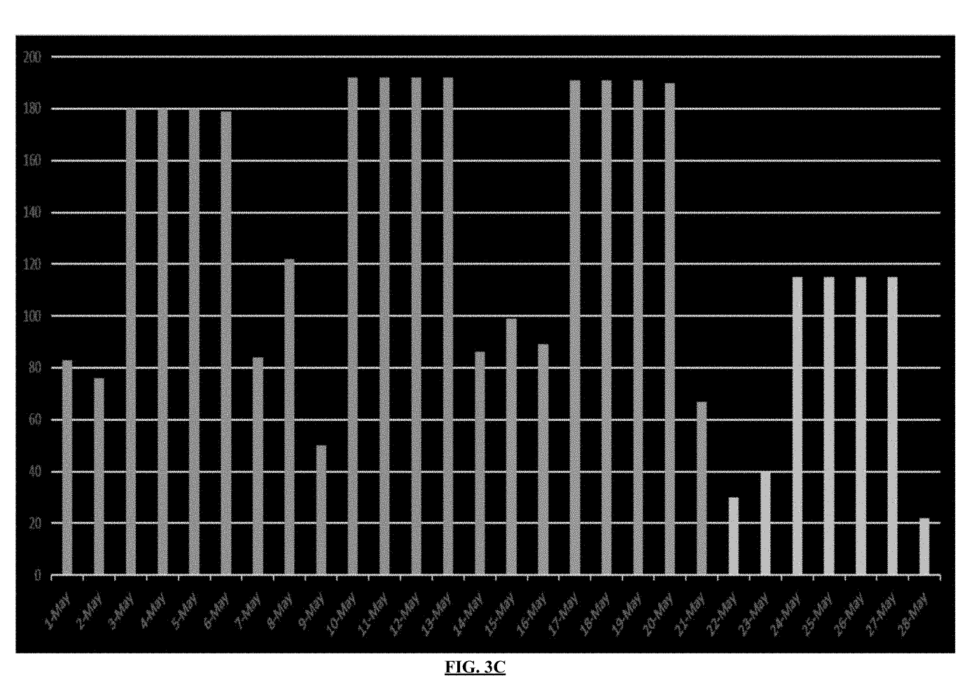

FIGS. 3A-3C illustrates examples of simulation performed by the work simulator 120. In this example, the work simulator utilized operations parameters that includes data on the locations, operators, their work rates, arrival patterns and sizes, task types, and etc. for three full but non-consecutive months.

As illustrated in FIGS. 3A-3C, for three locations (5-6 workdays) and two shifts per day, given the work rates and claim rates, the work simulator 120, using the method 200, obtained a 15.5% decrease in regular staff levels (if the actual ad-hoc operators were included, these decreases would be higher) for month 1 (FIG. 3A), 7% decrease for month 2 (FIG. 3B), and 5% decrease for month 3 (FIG. 3C) when compared with the regular staff working in actual operations. Month 1 had the least arrival volume and month 3 had the highest. Results of the work simulator 120, using the method 200, showed that all of the volume could be handled through regular operators. The work simulator 120, using the method 200, also gave a schedule in terms of shift, task type, and day for each operator incorporating all the limitations pertaining to day offs and utilization.

The methods and processes can be implemented with, contain, or be executed by one or more computer systems and/or processing nodes. The methods described above can also be stored on a non-transitory computer readable medium. Many of the elements described herein can be, comprise, or include computers systems and/or processing nodes.

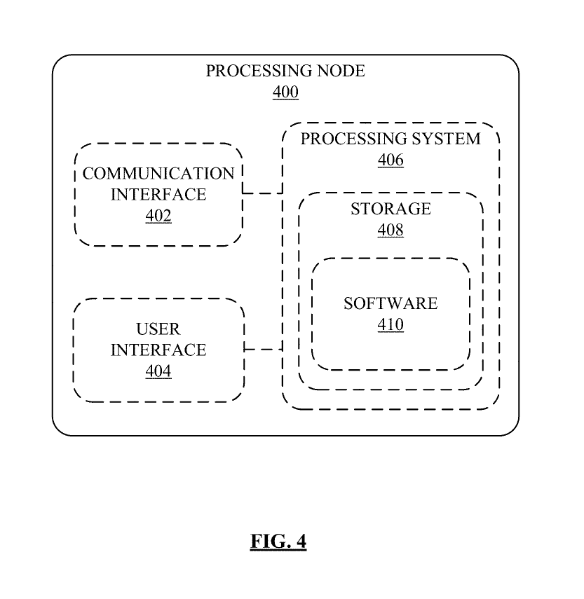

FIG. 4 depicts an exemplary processing node 400 comprising a communication interface 402, user interface 404, and processing system 406 in communication with communication interface 402 and user interface 404. Processing system 406 includes storage 408, which can comprise a disk drive, flash drive, memory circuitry, or other memory device. Storage 408 can store software 410 which is used in the operation of the processing node 400. Storage 408 can include a disk drive, flash drive, data storage circuitry, or some other memory apparatus. For example, storage 408 can include a buffer. Software 410 can include computer programs, firmware, or some other form of machine-readable instructions, including an operating system, utilities, drivers, network interfaces, applications, or some other type of software. For example, software 410 can include the work scheduler described above. Processing system 406 can include a microprocessor and other circuitry to retrieve and execute software 410 from storage 408. Processing node 400 can further include other components such as a power management unit, a control interface unit, etc., which are omitted for clarity. Communication interface 402 permits processing node 400 to communicate with other network elements. User interface 404 permits the configuration and control of the operation of processing node 400.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for simulating and optimizing performance of work in a distributed work environment, the method comprising:
determining operational parameters for one or more locations, the one or more locations comprising regular operators and ad-hoc operators;
optimizing a staffing function using the operational parameters to produce a staffing schedule,
wherein the staffing function defines a cost for work performed by the regular operators and the ad-hoc operators subject to service level agreement constraints;
determining one or more batches to be processed by the regular operators and ad-hoc operators of the one or more locations, the one or more batches comprises different tasks to be performed;
optimizing a task function using the staffing schedule and specifications of the different tasks to produce an assignment of the one or more batches to each of the regular operators and the ad-hoc operators at the one or more locations,
wherein the task function defines availability of the regular operators and the ad-hoc operators based on the staffing schedule and the specifications of the different tasks of the different tasks in the one or more batches;
optimizing a routing function using the assignment of the one or more batches to each of the regular operators and the ad-hoc operators at the one or more locations to produce a sequenced schedule of performance for the one or more batches assigned to each of the regular operators and ad-hoc operators,
wherein the routing function defines an order of performance of the one or more batches based on the assignment of batches; and
transmitting the batches, the staffing schedule, the assignment, and the sequenced schedule to the one or more locations.

2. The method of claim 1, wherein the operational parameters comprise an identification of the regular operators and ad-hoc operators, shift information for the one or more locations, and performance information for the regular operators and ad-hoc operators.

3. The method of claim 1, wherein the specifications of the different tasks an amount of time to complete each of the different tasks.

4. The method of claim 1, wherein optimizing the staffing function comprises:
minimizing the cost for work performed by the regular operators and the ad-hoc operators subject to service level agreement constraints.

5. The method of claim 1, wherein optimizing the task function comprises minimizing the task function.

6. The method of claim 1, wherein optimizing the routing function comprises minimizing the routing function.

7. The method of claim 1, the method further comprising:
determining one or more new batches to be processed by the regular operators and ad-hoc operators of the one or more locations, the one or more new batches comprises different tasks to be performed;
optimizing the task function using the staffing schedule and specifications of the different tasks to produce an assignment of the one or more new batches to each of the regular operators and the ad-hoc operators at the one or more locations, and
optimizing the routing function using the assignment of the one or more new batches to each of the regular operators and the ad-hoc operators at the one or more locations to produce a sequenced schedule of performance for the one or more new batches assigned to each of the regular operators and ad-hoc operators.

8. A processing node for simulating and optimizing performance of work in a distributed work environment, the processing node being configured to perform operations comprising:
determining operational parameters for one or more locations, the one or more locations comprising regular operators and ad-hoc operators;
optimizing a staffing function using the operational parameters to produce a staffing schedule,
wherein the staffing function defines a cost for work performed by the regular operators and the ad-hoc operators subject to service level agreement constraints;
determining one or more batches to be processed by the regular operators and ad-hoc operators of the one or more locations, the one or more batches comprises different tasks to be performed;
optimizing a task function using the staffing schedule and specifications of the different tasks to produce an assignment of the one or more batches to each of the regular operators and the ad-hoc operators at the one or more locations,
wherein the task function defines availability of the regular operators and the ad-hoc operators based on the staffing schedule and the specifications of the different tasks of the different tasks in the one or more batches;
optimizing a routing function using the assignment of the one or more batches to each of the regular operators and the ad-hoc operators at the one or more locations to produce a sequenced schedule of performance for the one or more batches assigned to each of the regular operators and ad-hoc operators,
wherein the routing function defines an order of performance of the one or more batches based on the assignment of batches; and
transmitting the batches, the staffing schedule, the assignment, and the sequenced schedule to the one or more locations.

9. The processing node of claim 8, wherein the operational parameters comprise an identification of the regular operators and ad-hoc operators, shift information for the one or more locations, and performance information for the regular operators and ad-hoc operators.

10. The processing node of claim 8, wherein the specifications of the different tasks an amount of time to complete each of the different tasks.

11. The processing node of claim 8, wherein optimizing the staffing function comprises:
minimizing the cost for work performed by the regular operators and the ad-hoc operators subject to service level agreement constraints.

12. The processing node of claim 8, wherein optimizing the task function comprises minimizing the task function.

13. The processing node of claim 8, wherein optimizing the routing function comprises minimizing the scheduling function.

14. The processing node of claim 8, the processing node being configured to perform operations further comprising:
determining one or more new batches to be processed by the regular operators and ad-hoc operators of the one or more locations, the one or more new batches comprises different tasks to be performed;
optimizing the task function using the staffing schedule and specifications of the different tasks to produce an assignment of the one or more new batches to each of the regular operators and the ad-hoc operators at the one or more locations, and
optimizing the routing function using the assignment of the one or more new batches to each of the regular operators and the ad-hoc operators at the one or more locations to produce a sequenced schedule of performance for the one or more new batches assigned to each of the regular operators and ad-hoc operators.

15. A non-transitory computer readable medium storing instructions for causing one or more processors to perform a method for simulating and optimizing performance of work in a distributed work environment, the method comprising:
determining operational parameters for one or more locations, the one or more locations comprising regular operators and ad-hoc operators;
optimizing a staffing function using the operational parameters to produce a staffing schedule,
wherein the staffing function defines a cost for work performed by the regular operators and the ad-hoc operators subject to service level agreement constraints;
determining one or more batches to be processed by the regular operators and ad-hoc operators of the one or more locations, the one or more batches comprises different tasks to be performed;
optimizing a task function using the staffing schedule and specifications of the different tasks to produce an assignment of the one or more batches to each of the regular operators and the ad-hoc operators at the one or more locations,
wherein the task function defines availability of the regular operators and the ad-hoc operators based on the staffing schedule and the specifications of the different tasks of the different tasks in the one or more batches;
optimizing a routing function using the assignment of the one or more batches to each of the regular operators and the ad-hoc operators at the one or more locations to produce a sequenced schedule of performance for the one or more batches assigned to each of the regular operators and ad-hoc operators,
wherein the routing function defines an order of performance of the one or more batches based on the assignment of batches; and
transmitting the batches, the staffing schedule, the assignment, and the sequenced schedule to the one or more locations.

16. The non-transitory computer readable medium of claim 15, wherein the operational parameters comprise an identification of the regular operators and ad-hoc operators, shift information for the one or more locations, and performance information for the regular operators and ad-hoc operators.

17. The non-transitory computer readable medium of claim 15, wherein the specifications of the different tasks an amount of time to complete each of the different tasks.

18. The non-transitory computer readable medium of claim 15, wherein optimizing the staffing function comprises:
minimizing the cost for work performed by the regular operators and the ad-hoc operators subject to service level agreement constraints.

19. The non-transitory computer readable medium of claim 15, wherein optimizing the task function comprises minimizing the task function.

20. The non-transitory computer readable medium of claim 15, wherein optimizing the routing function comprises minimizing the scheduling function.
